(19) United States
(12) Patent Application Publication
(10) Pub. No.: US 2014/0059769 A1
(43) Pub. Date: Mar. 6, 2014

(54) Adjustable Bed Base Having Foam Shroud With Openings

(71) Applicants: Chad A. Baker, Georgetown, KY (US); William R. Rohr, Joplin, MO (US)

(72) Inventors: Chad A. Baker, Georgetown, KY (US); William R. Rohr, Joplin, MO (US)

(73) Assignee: L&P PROPERTY MANAGEMENT COMPANY, South Gate, CA (US)

(21) Appl. No.: 13/604,779

(22) Filed: Sep. 6, 2012

(51) Int. Cl. A61G 7/015

(52) U.S. Cl. 5/613

(57) ABSTRACT

An adjustable bed (10) includes an adjustable bed base (12) for supporting a mattress (14). The adjustable bed base (12) comprises an articulated deck (50) comprising head, seat, leg and foot deck boards (52, 54, 56, 58) hingedly joined together and supported by a frame (32). A foam shroud is secured to the periphery of the articulated deck (50). The foam shroud may have multiple openings made by removing material from the shroud to aid in articulation of the shroud.

### FIELD OF THE INVENTION

This invention relates generally to adjustable beds and, more particularly, to an adjustable bed base for use with a mattress.

### BACKGROUND OF THE INVENTION

Adjustable beds have been used for many years to permit the user to adjust the head and foot sections of the bed to different positions. While originally only manually adjustable, the head and foot sections are currently moved or adjusted by motors operated by the user via a remote control.

Adjustable beds were originally designed principally for use in medical environments by patients who had to spend long periods of time in bed for reasons of health, injury, etc. However, more recently, adjustable beds are also being used in residential environments by users who have no health or physical impairment. An increasing number of people place televisions and other entertainment devices in the bedroom, and more time is spent lounging in bed. Hence, the bed, and in particular, an adjustable bed, is considered by many users an alternative piece of leisure furniture. As the market for leisure beds grows, there is continuing effort by suppliers to provide leisure beds that are more comfortable, have more options, for example, massage capabilities, more sophisticated controls, and are more affordable.

One development in adjustable beds is the development of a “wallhugger” adjustable bed. The wallhugger adjustable bed maintains the user in the same position with respect to adjacent appliances and furniture as the head portion of the bed is moved between flat and elevated positions. To achieve that purpose, as the head section pivots upward, an upper bed frame portion translates toward the head end of the bed with respect to a stationary lower bed frame section.

Many motorized adjustable beds utilize a lower shroud which extends downwardly from the deck of the adjustable bed and is secured thereto. The deck of the adjustable bed comprises multiple deck boards movable relative to one another upon activation of one or more motors residing underneath the deck.

The lower shroud gives the adjustable bed a desirable “box spring” type appearance when the adjustable bed is in a horizontal position. The lower shroud may function to protect a user from the moving components underneath the deck of the adjustable bed. However, when one or more portions of prior art adjustable beds are moved to an inclined position, the lower shroud may bulge outwardly in select locations, thus distorting the shape of the shroud and creating an unattractive appearance. In addition, such distortion of the lower shroud may create strain on the upholstered covering. Such strain may cause the upholstered covering to eventually rip or tear.

Lower shrouds of adjustable beds have been made of polyester fiber. Such shrouds are relatively expensive per board foot. In addition, known shrouds may tear upon repeated compression which commonly occurs in select locations of the shroud when the adjustable bed is inclined.

Thus, there is a need for an improved adjustable bed lower shroud which is less expensive per board foot than existing lower shrouds for adjustable beds.

There is further a need for a lower shroud for an adjustable bed which maintains its rigidity and shape when upholstered and subject to repeated compressive forces.

There is further a need for a lower shroud for an adjustable bed which provides less resistance when articulated than known shrouds.

### SUMMARY OF THE INVENTION

This invention comprises an adjustable bed having an adjustable or articulated deck comprising multiple support sections for supporting a mattress. The adjustable bed may be powered by a drive unit utilizing two motors or an electric motor driven linear actuator assembly. However, any other drive assembly, such as a conventional electrical motor driven screw and nut actuator system may be used in accordance with the present invention.

The adjustable bed comprises an adjustable bed base for supporting a mattress above the adjustable bed base. The adjustable bed may include cushioning material such as a mattress pad of foam or fiber or a pocketed spring assembly overlaying an articulated mattress support platform of the adjustable bed base.

According to one aspect of this invention, the adjustable bed base comprises a bed frame and an articulated mattress support platform comprising multiple support sections supported by the bed frame. The adjustable bed base further comprises a foam shroud secured to the articulated mattress support platform wherein the foam shroud comprises multiple particles of polyurethane foam bonded together.

According to another aspect of this invention, the adjustable bed base comprises a bed frame and an articulated mattress support platform comprising multiple support sections supported by the bed frame. The adjustable bed base further comprises a foam shroud secured to the articulated mattress support platform wherein the foam shroud has openings at predetermined locations to aid in articulation of the foam shroud without distorting the shape of the foam shroud.

According to another aspect of this invention, the adjustable bed base comprises a bed frame and an articulated mattress support platform comprising multiple support sections supported by the bed frame. The adjustable bed base further comprises a foam shroud secured to the articulated mattress support platform wherein portions of the foam shroud are removed at predetermined locations to aid in articulation of the foam shroud without distorting the shape of the foam shroud.

### BRIEF DESCRIPTION OF THE DRAWINGS

FIG. 1 is a perspective view of an adjustable bed in a horizontal position with an associated foam shroud;

FIG. 1A is an enlarged view of the encircled area 1A of FIG. 1;

FIG. 2 is a perspective view of the adjustable bed of FIG. 1 in an inclined position;

FIG. 3 is a partially disassembled view of a portion of the adjustable bed base of FIG. 1 with the adjustable bed base in a horizontal position;

FIG. 4 is a bottom perspective view of a portion of the adjustable bed base of FIG. 1 showing rectangular openings in the foam shroud of the adjustable bed base;

FIG. 5 is an enlarged view of the encircled area 5 of FIG. 4;

FIG. 5A is an enlarged view, similar to FIG. 5, of a portion of an alternative embodiment of foam shroud;

FIG. 5B is an enlarged view, similar to FIG. 5, of a portion of an alternative embodiment of foam shroud;

FIG. 5C is an enlarged view, similar to FIG. 5, of a portion of an alternative embodiment of foam shroud;

FIG. 5D is a cross-sectional view of a portion of an alternative embodiment of foam shroud;

FIG. 5E is an enlarged view, similar to FIG. 5, of a portion of an alternative embodiment of foam shroud;

FIG. 5F is an enlarged view, similar to FIG. 5, of a portion of an alternative embodiment of foam shroud;

FIG. 6 is an enlarged view of the encircled area 6 of FIG. 4;

FIG. 6A is an enlarged view, similar to FIG. 6, of a portion of an alternative embodiment of foam shroud;

FIG. 6B is an enlarged view, similar to FIG. 6, of a portion of an alternative embodiment of foam shroud;

FIG. 6C is an enlarged view, similar to FIG. 6, of a portion of an alternative embodiment of foam shroud;

FIG. 6D is an enlarged view, similar to FIG. 6, of a portion of an alternative embodiment of foam shroud;

FIG. 6E is an enlarged view, similar to FIG. 6, of a portion of an alternative embodiment of foam shroud;

FIG. 6F is an enlarged view, similar to FIG. 6, of a portion of an alternative embodiment of foam shroud;

FIG. 6G is an enlarged view, similar to FIG. 6, of a portion of an alternative embodiment of foam shroud;

FIG. 6H is an enlarged view, similar to FIG. 6, of a portion of an alternative embodiment of foam shroud;

FIG. 6I is an enlarged view, similar to FIG. 6, of a portion of an alternative embodiment of foam shroud;

FIG. 6J is an enlarged view, similar to FIG. 6, of a portion of an alternative embodiment of foam shroud;

FIG. 6K is an enlarged view, similar to FIG. 6, of a portion of an alternative embodiment of foam shroud;

FIG. 6L is an enlarged view, similar to FIG. 6, of a portion of an alternative embodiment of foam shroud;

FIG. 7 is perspective view of an adjustable bed in a horizontal position with another version of foam shroud;

FIG. 8 is a perspective view of the adjustable bed of FIG. 7 in an inclined position;

FIG. 9 is a bottom perspective view of a portion of the adjustable bed base of FIG. 1, the foam shroud of the adjustable bed base being covered in an upholstered covering; and

FIG. 10 is a bottom perspective view of a portion of an alternative embodiment of adjustable bed base showing an alternative foam shroud.

### DETAILED DESCRIPTION OF THE DRAWINGS

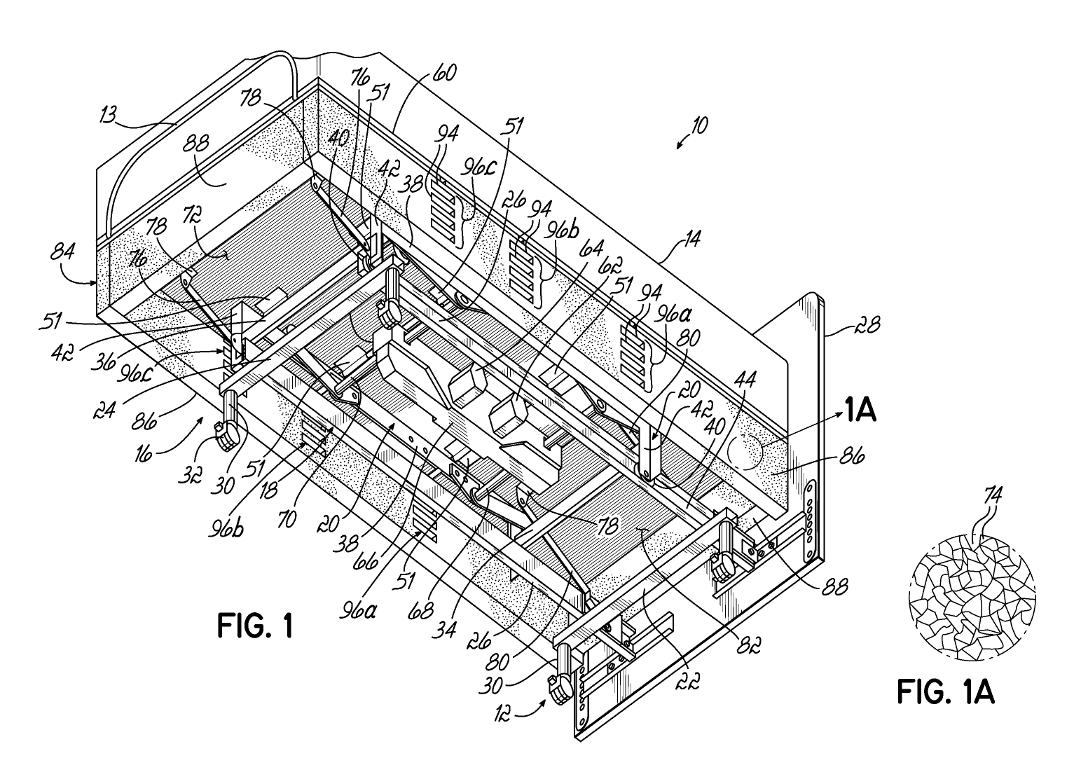

Referring to the drawings, and particularly to FIG. 1, there is illustrated an adjustable bed 10 comprising an adjustable bed base 12 supporting a mattress 14. The adjustable bed 10 may be used to support any type of mattress including an air mattress, a coil spring mattress or any other type of mattress. The mattress does not form part of the present invention. The adjustable bed base 12 includes a generally U-shaped stop 13 at the foot end of the adjustable bed 10 to prevent the mattress 14 from moving rearwardly.

The adjustable bed base 12 comprises a bed frame 16 having a stationary lower frame 18 and a movable upper frame 20 movably mounted on the lower frame 18. Although one configuration of bed frame 16 is illustrated and described, the present invention may be used with any conventional adjustable bed base frame. For example, the mechanism used to move the sections of the adjustable bed base may use one or two motors. The present invention does not intend to limit or restrict the mechanism used to raise or lower the portions or sections of the adjustable bed base.

The lower frame 18 has head and foot end rails 22, 24, respectively and left and right side rails 26. The rails 22, 24 and 26 are joined at their ends to form the generally rectangular lower frame 18. The lower frame 18 at the head end is joined to a head board 28. A plurality of caster brackets 30 are secured to and extend down from the end rails 22, 24 of the lower frame 18. A plurality of casters 32, each having a stem (not shown) are received inside the caster brackets 30 for supporting the adjustable bed 10 on the floor and enabling the adjustable bed 10 to be rolled from location to location.

The upper frame 20 includes a head rail 34, a foot rail 36 and left and right side rails 38. The rails 34, 36 and 38 are rigidly connected at their ends with fasteners to form the generally rectangular movable upper frame 20. The upper frame side rails 38 are made of angle stock, and the upper frame 20 is movably mounted on the lower frame 18 by four wheels 40 (only two being shown in FIG. 1) which are rotatably mounted to the ends of legs 42. The wheels 40 ride in C-shaped channels or tracks 44 forming the left and right side rails 26 of the stationary lower frame 18.

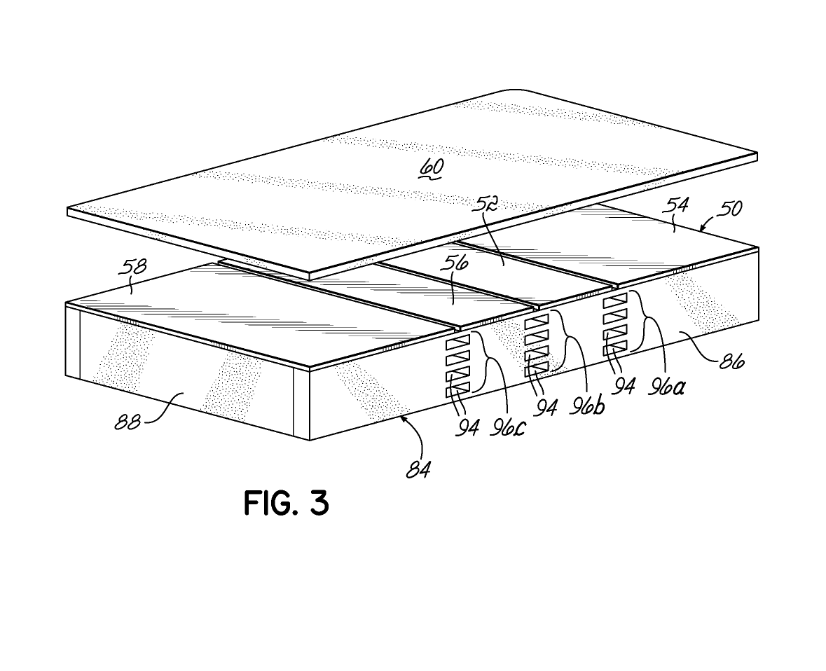

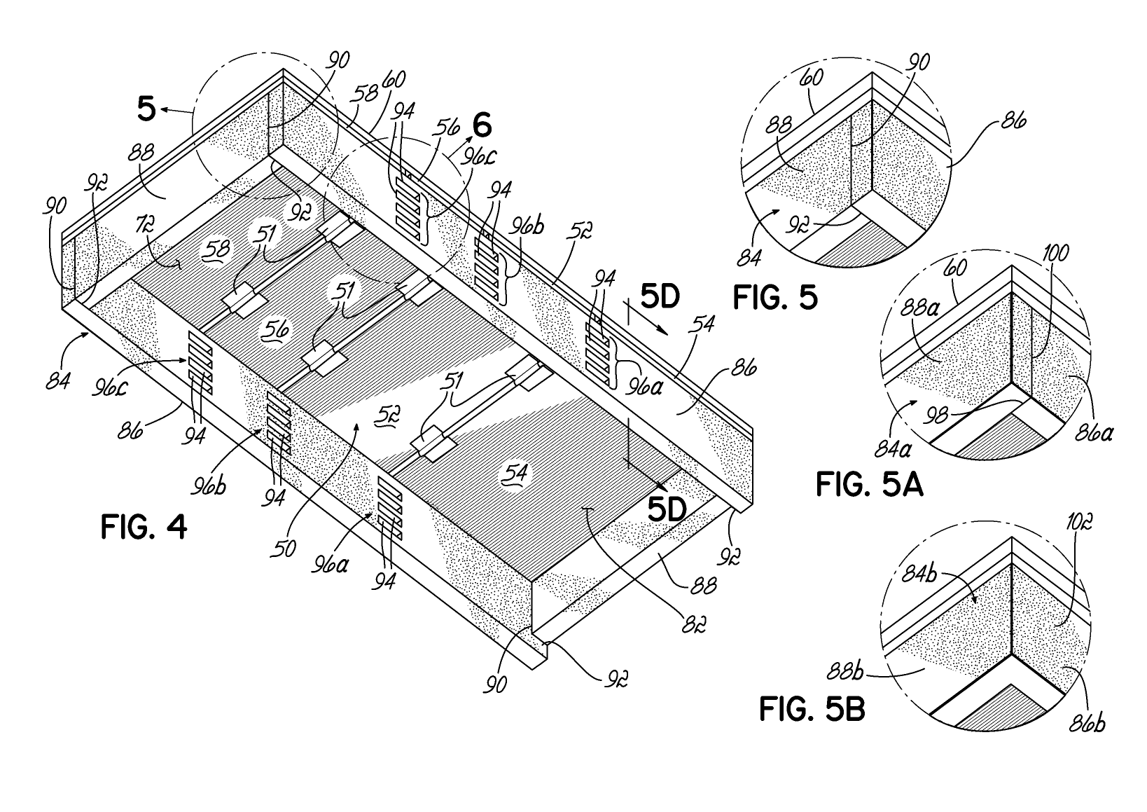

As best illustrated in FIGS. 3 and 4, an articulated deck or mattress support platform 50 comprises a first or seat deck board or section 52 connected to the upper frame 20 and a head deck board or section 54 is pivotally connected to a head end of the seat deck board or section 52 with hinges 51 (see FIG. 1). A leg deck board or section 56 is pivotally connected to a foot end of the seat deck board or section 52 with hinges 51; and a foot deck board or section 58 is pivotally connected to a foot end of the leg deck board or section 56 with hinges 51. Each of the deck boards is preferably the same width but any two deck boards may be different widths, if desired. Although, two hinges are shown securing adjacent deck sections, any number of hinges may be used including one continuous hinge. The mattress supporting sections may be made from any desired material that is capable of properly supporting a user on a mattress, for example, a plywood or oriented strand board (OSB) material.

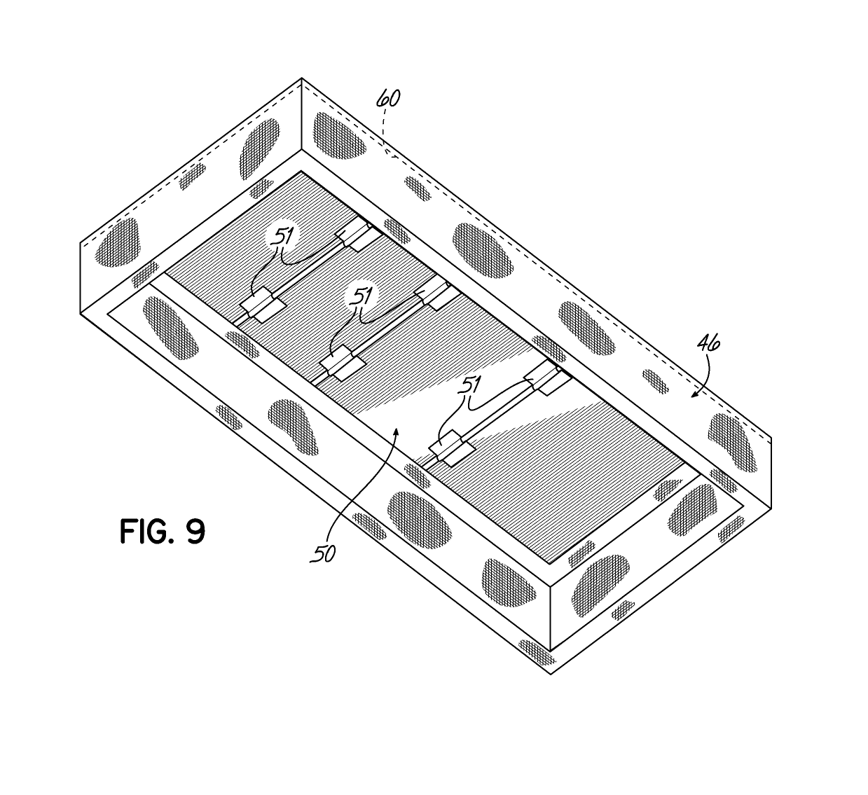

Cushioning material such as a mattress pad 60 is mounted over and covers the articulated deck or mattress support platform 50. Normally, the articulated deck or mattress support platform 50 and mattress pad 60 are enclosed within a covering 46, as shown in FIG. 9 and described below. Mattress 14 rests atop the upholstered bed base 12.

As shown in FIG. 1, head and leg motors 62, 64, respectively, are mounted to a powered drive assembly or unit 66 which mechanically couples the head and leg motors 62, 64 to respective head and leg torque tubes 68, 70, in a known manner Operating the head motor 62 rotates the torque tube 68 and raises the head section 54 of the articulated deck or mattress support platform 50. With the adjustable bed of FIG. 1, as the head section 54 is raised, the upper frame 20 moves or translates towards the head end of the bed; and the head section 54 remains close to the headboard 28. Operating the leg motor 64 rotates the leg torque tube 70 and raises the junction of the leg and foot sections 56, 58, respectively. This type of adjustable bed is known in the industry as a Wallhugger® bed. However, the present invention may be used with any adjustable bed or adjustable bed base having any type of frame including a stationary frame.

The adjustable bed 10 further comprises two foot links 76 or connectors, of the same length. Each of the foot links 76 is pivotally secured at a lower end to the movable upper frame 20 so that each pivots about a horizontal pivot axis. Each foot link 76 is pivotally secured at its upper end to a bracket 78 fixed to the lower surface 72 of the foot deck board 58.

The adjustable bed 10 further comprises two head links 80 or connectors, of the same length. Each of the head links 80 is pivotally secured at a lower end to the movable upper frame 20 so that each pivots about a horizontal pivot axis. Each head link 80 is pivotally secured at its upper end to a bracket 78 fixed to the lower surface 82 of the head deck board 54.

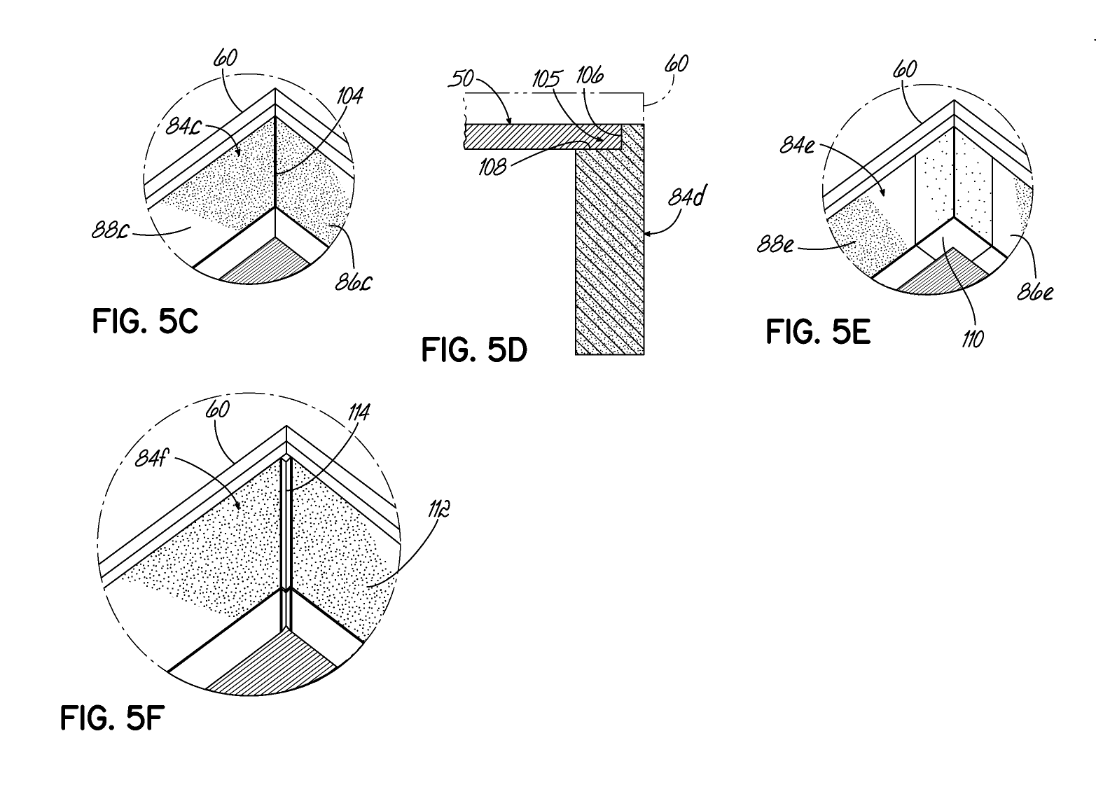

As best illustrated in FIGS. 3 and 4, the adjustable bed base 12 further comprises a lower border or shroud 84 generally rectangular in shape and secured to the articulated deck 50. More particularly, the lower border or shroud 84 may be secured to the periphery or peripheral edges of the articulated deck 50 using adhesive or in any other known fashion. In the embodiment shown in FIGS. 1-6, lower border or shroud 84 comprises four pieces of foam secured together, two side pieces 86 and two end pieces 88. The pieces may be glued together. In this embodiment, the end surfaces 90 of each end piece 88 are secured to side surfaces 92 of the side pieces 86, as best shown in FIG. 5. As best shown in FIG. 4, in the illustrated embodiment, the height of the end piece 88 at the head end of the shroud 84 is less than the height of the other three pieces of the shroud 84 in order to accommodate different headboards. Of course, the four pieces of the shroud 84 may be the same height or be any desired heights. For example, the two end pieces 88 may be the same height which may be different than the two side pieces 86.

As shown in FIG. 1A, each piece of the lower border or shroud 84 is made of foam and more particularly a foam called “Rebond” foam in the industry made from irregularly-shaped pieces or particles 74 of polyurethane foam bonded together. The pieces or particles 74 of polyurethane foam may be produced by grinding flexible polyurethane foam into small particles before bonding them together. This type of product has been used underneath carpet but has not been used in the bedding industry and particularly not in the manufacture of adjustable beds heretofore.

One purpose of the lower border 84 is to provide an attractive appearance when an upholstered covering 46 shown in FIG. 9 is put over the adjustable bed base 12.

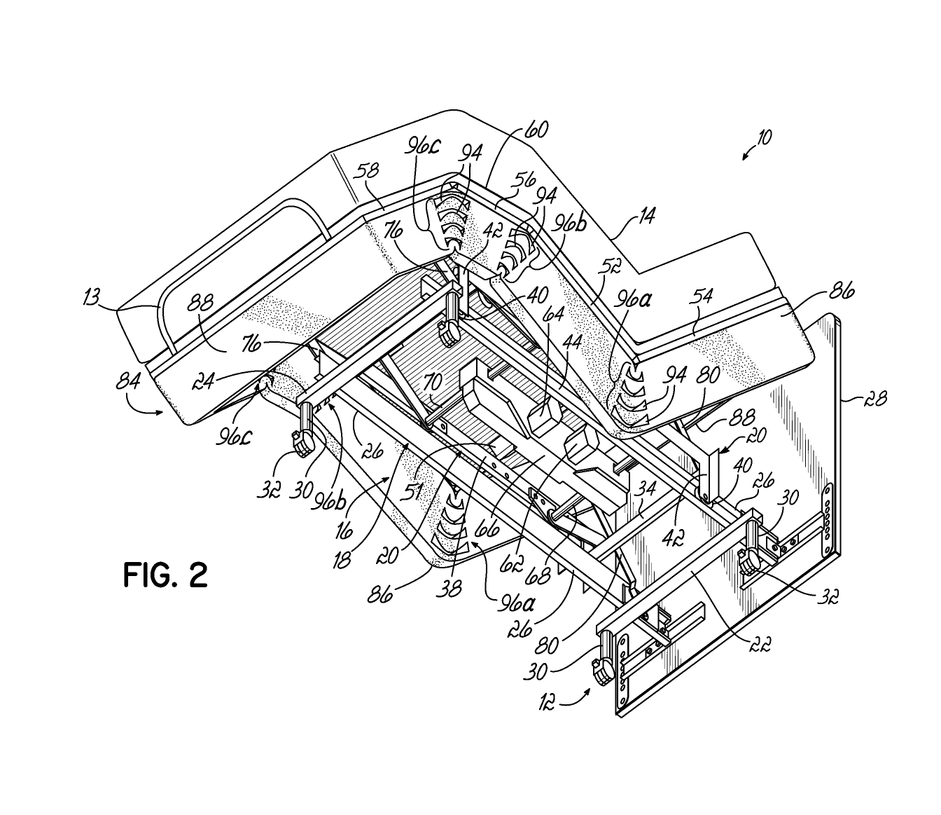

As shown in FIGS. 1-6, the lower border or shroud 84 has multiple openings 94, each opening 94 being rectangular-shaped extending through the thickness of the foam shroud or lower border 84. The openings 94 may be created by removing material from one of the foam shroud side pieces before the foam pieces 86, 88 are assembled into the completed lower foam border 84. The openings 94 are each rectangular in shape and arranged in groups 96a, 96b, 96c, each group of openings 94 being located where the foam shroud 84 articulates or bends, as shown in FIG. 2. Although four openings 94 are shown per group, any number of openings may be located in a group at a predetermined location. The locations of the groups of openings may be different depending on the length of the bed base.

In the embodiment shown in FIGS. 1-6, three such groups 96a, 96b, 96c of openings are illustrated, one group 96a of openings 94 being located approximately below where the head deck board 54 is hinged to the seat deck board 56; a second group 96b of openings 94 being located approximately below where the seat deck board 56 is hinged to the leg deck board 58 and lastly, group 96c of openings 94 being located below approximately where the leg deck board 58 is hinged to the foot deck board 60. Any number of groups of openings may be present in the foam shroud, depending on the number of articulations in the deck. For example, in an adjustable bed in which only the head board inclines and the foot end does not, there may be only one group or set of openings in the lower foam shroud.

FIG. 5 illustrates a corner portion of foam shroud 84. Foam shroud 84 comprises four pieces of foam, two end pieces 88 and two side pieces 86 (only one of each being shown). In this embodiment of foam shroud 84, the end surfaces 90 of the end pieces 88 are glued or secured to the side surfaces 92 of the side pieces 86.

FIG. 5A illustrates a corner portion of an alternative embodiment of foam shroud 84a. This foam shroud 84a comprises four pieces of foam, two end pieces 88a and two side pieces 86a (only one of each being shown). However, in this embodiment of foam shroud 84a, the end surfaces 98 of the end pieces 88a are glued or secured to the side surfaces 100 of the side pieces 86a.

FIG. 5B illustrates a corner portion of an alternative embodiment of foam shroud 84b. This foam shroud 84b comprises a single or uniform piece of foam 102 rather than being made of multiple pieces secured together.

FIG. 5C illustrates a corner portion of an alternative embodiment of foam shroud 84c. This foam shroud 84c comprises four pieces of foam, two end pieces 88c and two side pieces 86c (only one of each being shown). However, in this embodiment of foam shroud 84c, each of the pieces 86c, 88c have opposed beveled or angled edges 104 which are glued or secured together to make a corner of the foam shroud 84c.

FIG. 5D illustrates a cross-sectional portion of an alternative embodiment of foam shroud 84d secured to and extending downwardly from the deck 50. This foam shroud 84d may comprise any number of pieces of foam joined at the corners in any manner described or illustrated herein. However, in this embodiment the foam shroud 84d has a cutout 105 comprising a vertical surface 106 and a horizontal surface 108 into which fits the deck. The foam shroud 84d may be glued or otherwise secured to the deck in this manner

FIG. 5E illustrates a corner portion of an alternative embodiment of foam shroud 84e. This foam shroud 84e comprises two end pieces 88e and two side pieces 86e and four corner pieces 110 (only one of each being shown). The corner foam pieces 110 of foam shroud 84e have a different density than the density of the end and side pieces 88e, 86e. All eight of the pieces are glued or secured together to create foam shroud 84e.

FIG. 5F illustrates a corner portion of an alternative embodiment of foam shroud 84f. This foam shroud 84f comprises a single piece of foam 112 rather than being made of multiple pieces secured together. However, the single piece of foam 112 has a grove 114 cut therein at each corner.

The openings through the foam shroud may be various geometric shapes dependent on the shroud dimensions, angle of articulation and aesthetics. The openings in the foam shroud assist in the articulation and reduce the amount of energy required to articulate the bed; i.e. the motors will do less work. The openings allow the mass of the foam to re-orient during articulation of the bed base and provide a lower resistance to movement during articulation. The spacing and size of the openings may be dependent upon the thickness and density of the foam shroud. Material may be removed from the shroud in order to create the openings, regardless of the shapes of the openings.

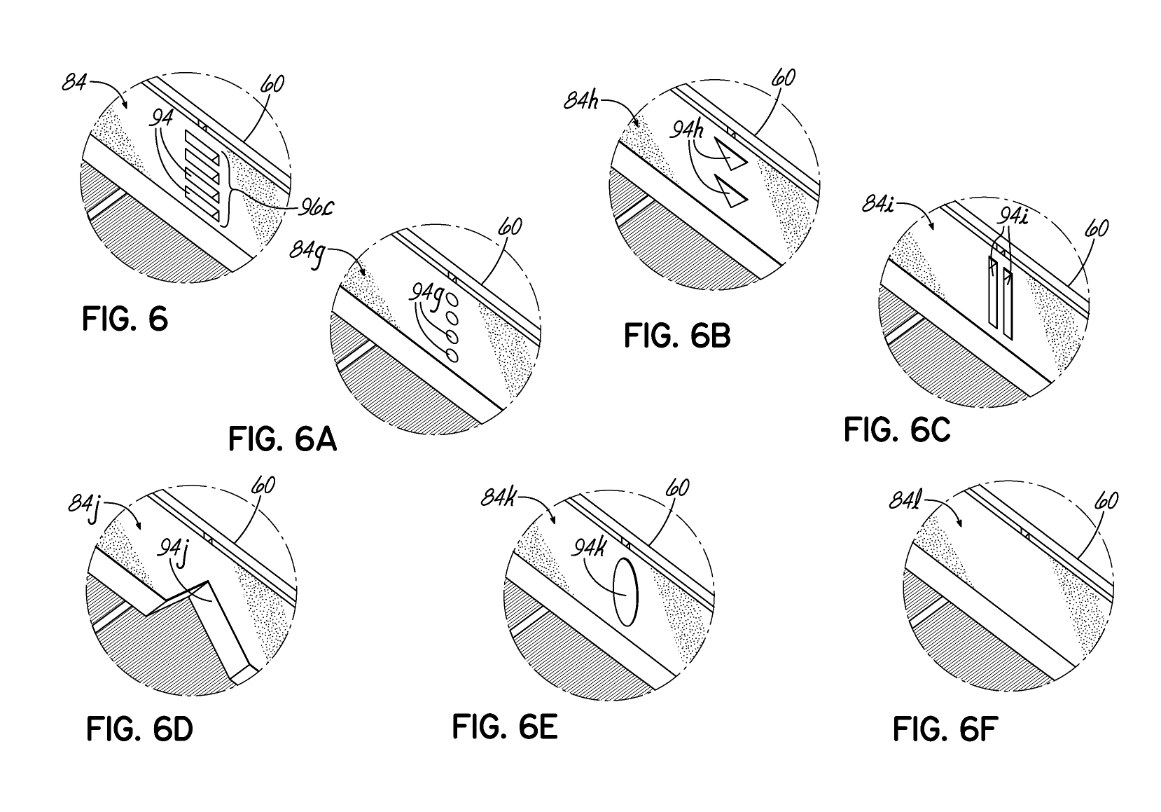

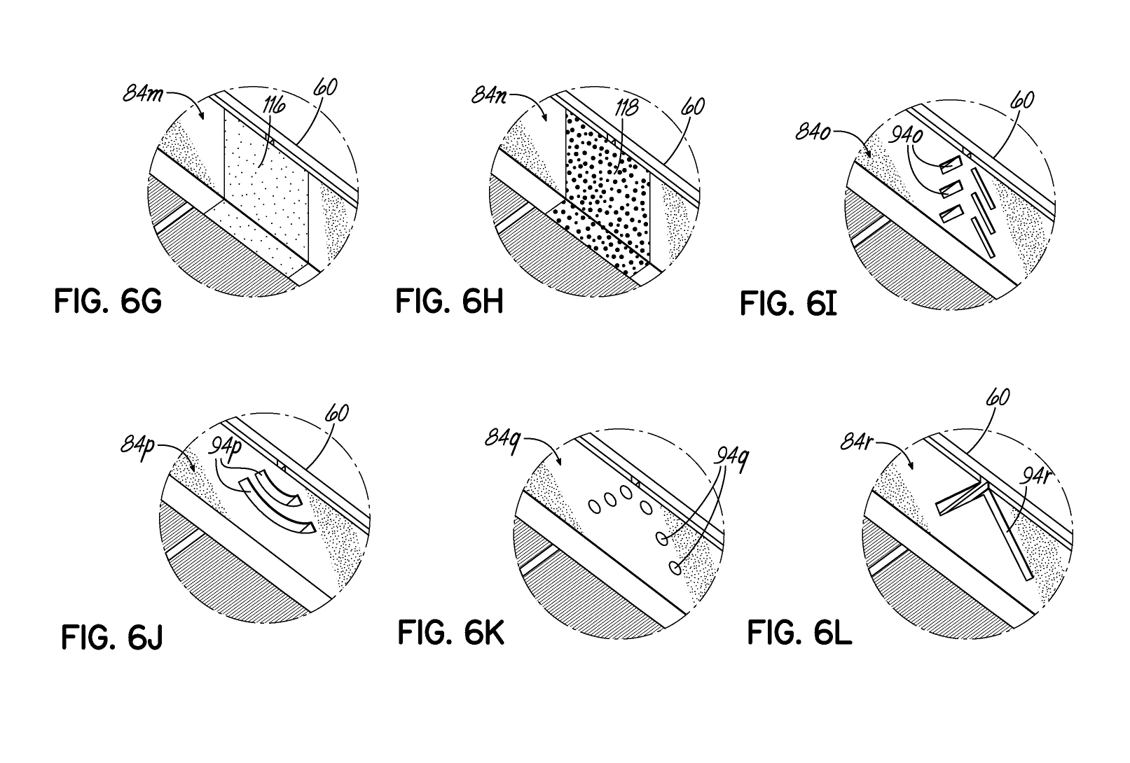

FIG. 6 illustrates a portion of a side piece 86 of foam shroud 84. In this embodiment of foam shroud 84, four rectangular openings 94 are located in a vertically spaced orientation at each articulation point in groups 96a, 96b and 96c. FIG. 6 illustrates the group 96c of openings 94 in one of the sides pieces 86 of foam shroud 84 where the foot deck board 58 hinges with respect to the leg deck board 56. Each group of openings in each of the side pieces of the foam shroud has a matching group of openings in the opposite side piece of the foam shroud at a corresponding location to aid in the articulation or bending of the foam shroud.

FIG. 6A illustrates a portion of an alternative embodiment of foam shroud 84g. This foam shroud 84g has openings 94g which are circular in shape at each of the articulation locations. Although four circular openings 94g are illustrated in FIG. 6A, any number of openings may be used at any articulation location of the foam shroud.

FIG. 6B illustrates a portion of an alternative embodiment of foam shroud 84h. This foam shroud 84h has openings 94h which are triangular in shape at each of the articulation locations. Although two triangular openings 94g are illustrated in FIG. 6B, any number of openings may be used at any articulation location of the foam shroud.

FIG. 6C illustrates a portion of an alternative embodiment of foam shroud 84i. This foam shroud 84i has openings 94i which are rectangular in shape, the longer dimensions of the rectangles being oriented vertically. The openings 94i are located at each of the articulation locations. Although two rectangular openings 94i are illustrated in FIG. 6C, any number of openings may be used at any articulation location of the foam shroud.

FIG. 6D illustrates a portion of an alternative embodiment of foam shroud 84j. This foam shroud 84j has triangular cutouts 94j in which material is removed from the shroud. The triangular cutouts 94j are located at each of the articulation locations.

FIG. 6E illustrates a portion of an alternative embodiment of foam shroud 84k. This foam shroud 84k has openings 94k which are oval in shape at each of the articulation locations. Although one oval opening 94k is illustrated in FIG. 6E, any number of oval openings may be used at any articulation location of the foam shroud.

FIG. 6F illustrates a portion of an alternative embodiment of foam shroud 84l. This foam shroud 84l has no openings at each of the articulation locations.

FIG. 6G illustrates a portion of an alternative embodiment of foam shroud 84m. This foam shroud 84m has no openings at the articulation locations. However, pieces 116 of foam are located at the articulation locations. The density of the foam of the foam pieces 116 at the articulation locations is less than the density of the foam of the remainder of the foam shroud 84m.

FIG. 6H illustrates a portion of an alternative embodiment of foam shroud 84n. This foam shroud 84n has no openings at the articulation locations. However, pieces 118 of foam are located at the articulation locations. The density of the foam of the foam pieces 118 at the articulation locations is greater than the density of the foam of the remainder of the foam shroud 84n.

FIG. 6I illustrates a portion of an alternative embodiment of foam shroud 84o. This foam shroud 84o has multiple rectangular openings 94o arranged in a V-shaped pattern at each of the articulation locations. Although six circular openings 94q are illustrated in FIG. 6I, any number of such openings may be used at any articulation location of the foam shroud.

FIG. 6J illustrates a portion of an alternative embodiment of foam shroud 84p. This foam shroud 84p has multiple arcuate openings 94p arranged in a layer-shaped pattern at each of the articulation locations. Although two arcuate openings 94p are illustrated in FIG. 6J, any number of arcuate openings may be used at any articulation location of the foam shroud.

FIG. 6K illustrates a portion of an alternative embodiment of foam shroud 84q. This foam shroud 84q has multiple round or circular openings 94q arranged in a V-shaped pattern at each of the articulation locations. Although six circular openings 94q are illustrated in FIG. 6K, any number of openings may be used at any articulation location of the foam shroud.

FIG. 6L illustrates a portion of an alternative embodiment of foam shroud 84r. This foam shroud 84r has multiple rectangular openings 94r, each in the shape of a large V at each of the articulation locations.

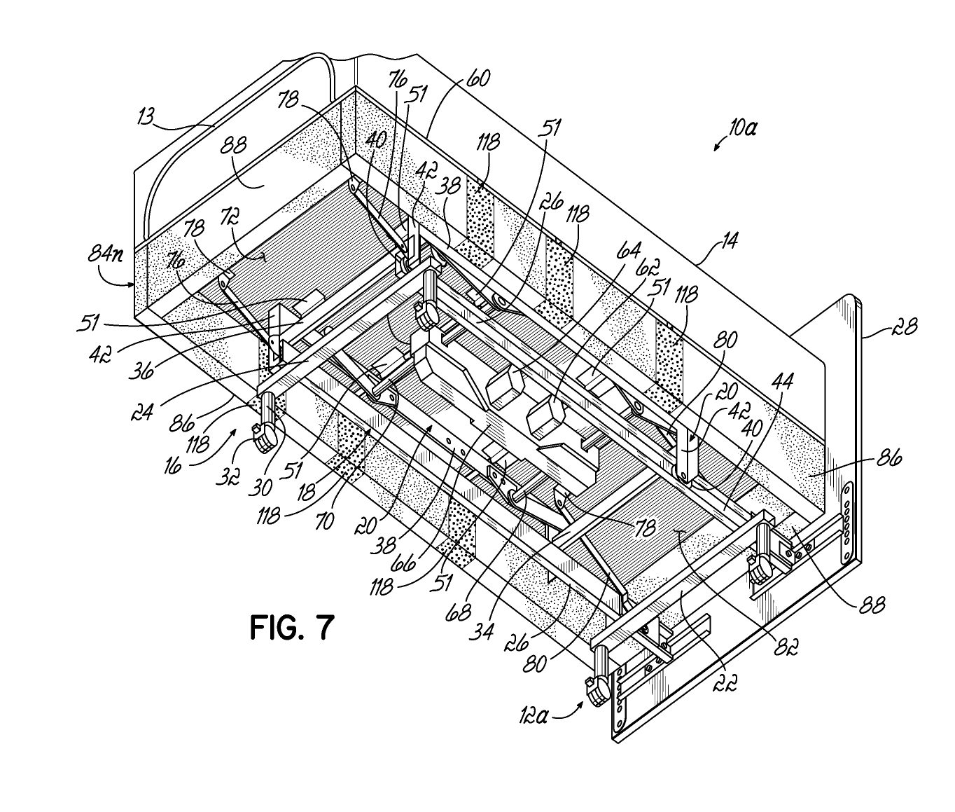

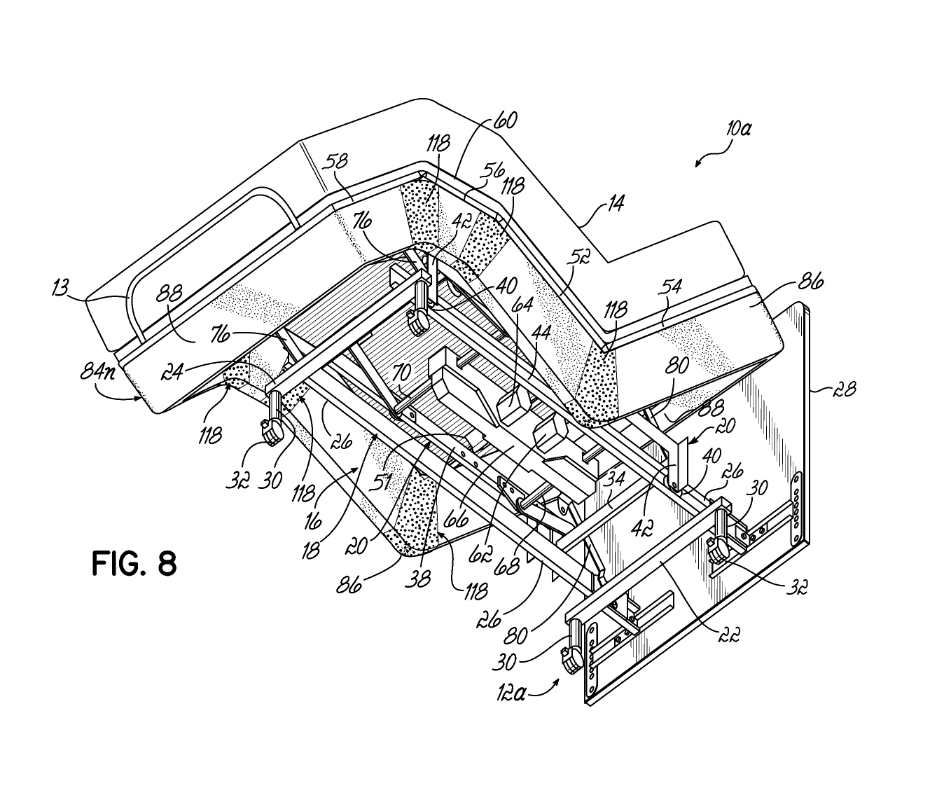

FIGS. 7 and 8 illustrate an adjustable bed 10a having an alternative bed base 12a having the foam shroud 84n of FIG. 6H. The foam shroud 84n has three areas of articulation on each of the side pieces 86 of the foam shroud 84n. Pieces of foam 118 are located at each of the articulation locations.

FIG. 9 illustrates the portion of the bed base 12 shown in FIG. 4 covered with an upholstered covering 46. The upholstered covering 46 covers the upper surface of the bed base 12 and extends downwardly around the foam shroud 84 and is secured to the underside of the deck 50 in any conventional manner such as with glue.

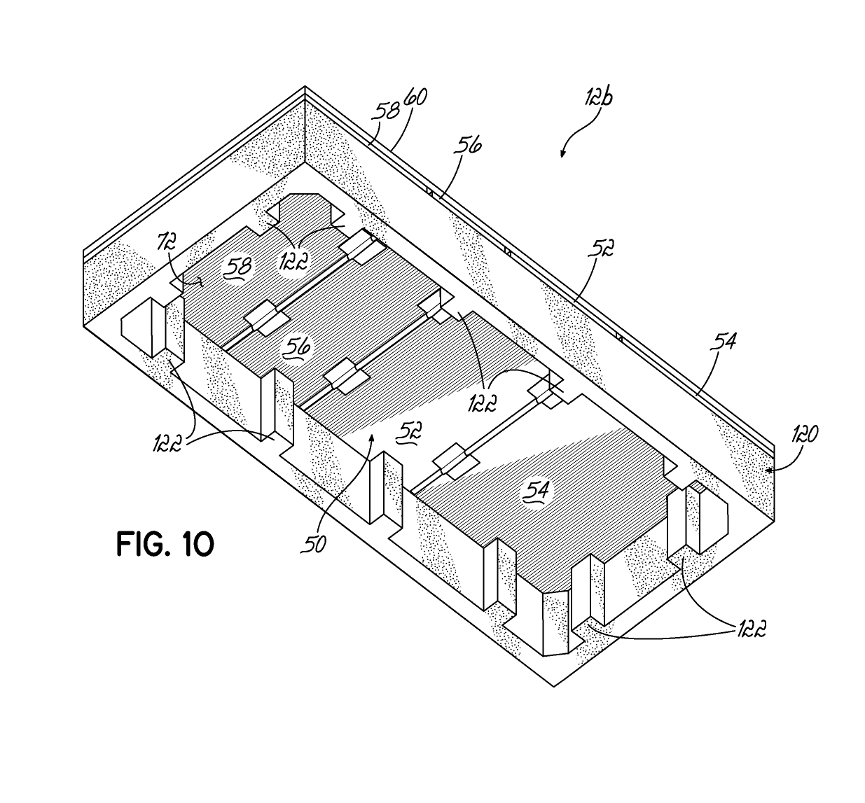

FIG. 10 illustrates a portion of an alternative embodiment of bed base 12b having a foam shroud 120. The foam shroud 120 comprises a unitary piece of foam having multiple inwardly extending, spaced internal stabilizers 122 integral with the remainder of the foam shroud 120. The internal stabilizers 122 prevent the foam from rolling or bending vertically towards the center of the deck 50 during articulation. The foam shroud 120 is shown attached to deck 50 as described herein. Although foam shroud 120 is shown as being one unitary piece, it may comprise multiple pieces. Although foam shroud 120 is shown as lacking any openings herein, it may have any number of openings at any desired articulation location. Although FIG. 10 shows four internal stabilizers 122 on each side of the foam shroud 120 and two internal stabilizers 122 on each end of the foam shroud 120, any number of internal stabilizers 122 extending inwardly towards the center of the bed base may be incorporated on any of the sides or ends of the foam shroud. Although the internal stabilizers 122 are shown having a rectangular cross-sectional configuration, they may be other sizes or shapes. If desired, internal stabilizers may be located only along the sides and omitted from the ends of the foam shroud.

Although we have described several embodiments of the invention, we do not intend to be limited except by the scope of the following claims. For example, the headboard may be omitted.

We claim:

1. An adjustable bed base for supporting a mattress, said adjustable bed base comprising:
a bed frame;
an articulated mattress support platform comprising multiple support sections supported by the bed frame;
a foam shroud secured to the articulated mattress support platform wherein the foam shroud comprises multiple particles of polyurethane foam bonded together.

2. The adjustable bed base of claim 1 wherein the foam shroud is secured to peripheral edges of the articulated mattress support platform.

3. The adjustable bed base of claim 1 wherein the foam shroud is secured to the articulated mattress support platform with adhesive.

4. The adjustable bed base of claim 1 wherein the foam shroud comprises multiple pieces.

5. The adjustable bed base of claim 5 wherein at least two of the pieces of foam shroud have different densities.

6. The adjustable bed base of claim 1 wherein the foam shroud comprises a unitary piece of foam.

7. The adjustable bed base of claim 1 wherein portions of the foam shroud are removed at predetermined locations to aid in articulation of the foam shroud.

8. The adjustable bed base of claim 1 wherein the foam shroud has multiple openings at predetermined locations to aid in articulation of the foam shroud.

9. The adjustable bed base of claim 1 wherein articulation areas of said foam shroud have a different density than the other areas of the foam shroud.

10. An adjustable bed base for supporting a mattress, said adjustable bed base comprising:
a bed frame;
an articulated mattress support platform comprising multiple support sections supported by the bed frame;
a foam shroud secured to the articulated mattress support platform wherein the foam shroud has multiple openings at predetermined locations to aid in articulation of the foam shroud.

11. The adjustable bed base of claim 10 wherein said openings are triangular in shape.

12. The adjustable bed base of claim 10 wherein said openings are rectangular in shape.

13. The adjustable bed base of claim 10 wherein the foam shroud comprises multiple particles of polyurethane foam bonded together.

14. An adjustable bed base for supporting a mattress, said adjustable bed base comprising:
a bed frame;
an articulated mattress support platform comprising multiple support sections supported by the bed frame;
a foam shroud secured to the articulated mattress support platform wherein portions of the foam shroud are removed at predetermined locations to aid in articulation of the foam shroud.

15. The adjustable bed base of claim 14, wherein the foam shroud comprises multiple particles of polyurethane foam bonded together.

16. The adjustable bed base of claim 14, wherein the foam shroud is secured to peripheral edges of the articulated mattress support platform.

17. The adjustable bed base of claim 14 wherein the foam shroud comprises multiple pieces.

18. The adjustable bed base of claim 17 wherein at least two of the multiple pieces of foam have different densities.

19. The adjustable bed base of claim 14 wherein the foam shroud comprises a unitary piece of foam.

20. The adjustable bed base of claim 14 wherein the removed portions of the foam shroud are wedges.

21. The adjustable bed base of claim 14 wherein the removed portions of the foam shroud are triangular in shape.

22. The adjustable bed base of claim 14 wherein the removed portions of the foam shroud are triangular in shape.

23. The adjustable bed base of claim 14 wherein the removed portions of the foam shroud are rectangular in shape.
